(19) United States
(12) Patent Application Publication
(10) Pub. No.: US 2007/0186468 A1
(43) Pub. Date: Aug. 16, 2007

(54) Plant pot with fluid reservoir

(76) Inventor: Haim Amram Ben-Simhon, Haifa (IL)

Correspondence Address: Dr. HAIM AMRAM BEN-SIMHON, 18/24 Drifuss Street, HAIFA, 35434, IL

(21) Appl. No.: 10/900,444

(22) Filed: Jul. 28, 2004

(30) Foreign Application Priority Data
Feb. 3, 2004 (IL) 160198

(51) Int. Cl. A01G 9/02

(52) U.S. Cl. 47/79

(57) ABSTRACT

A double wall plant pot, having a soil compartment and a fluid compartment, is presented. It includes also means to regulate the rate of flow from the fluid compartment to the soil compartment, and means to prevent soil from penetrating to the fluid compartment. Both hydrostatic and capillary pressures drive the fluid from the fluid into the soil the soil compartment respectively. Also described are means to aerate the soil compartment.

### BACKGROUND OF THE INVENTION

Many designs of double wall plant pot have been proposed. However they fail to adequately aerate the soil compartment. They also fail to regulate the flow of fluid from the circular reservoir to the soil compartment. The proposed plant pot will enable not to water the plant for a long period of time and will enable to supply fluid according to the needs of the plant.

### DISCLOSURE

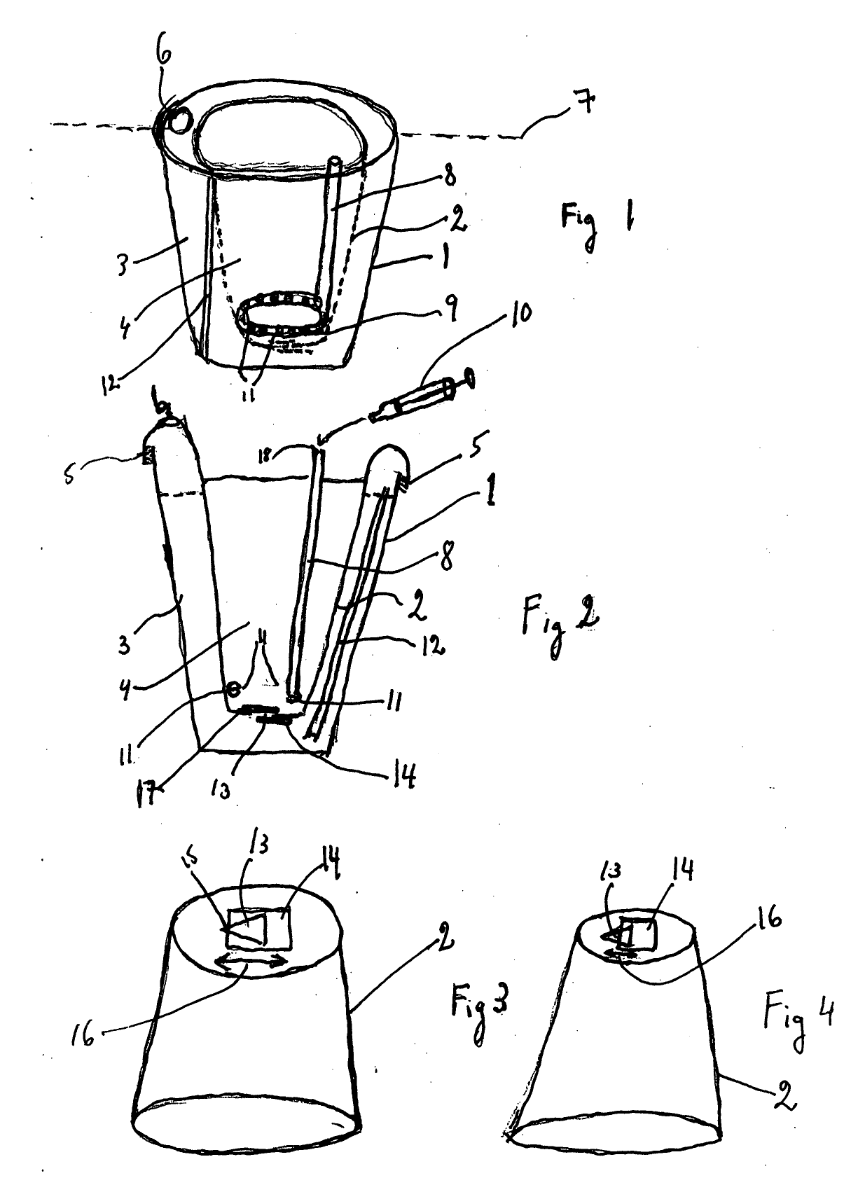

Please refer to FIGS. 1, 2, 3 and 4. FIG. 2 is the cross-section at level 7 of the general view FIG. 1.

A plastic or clay double wall plant pot having outer wall 1 and inner wall 2. The two walls define two compartments; outer compartment 3 which is the fluid compartment, and inner compartment 4 which is the soil and plant compartment.

The inner wall 2 screws to the outer wall 1 by means of circular screw feature 5 on both the inner and outer walls. Cover 6 covers an opening and enables the refilling of the fluid compartment.

Elongated tube 8 beginning in the air above the soil compartment and ending as a circular tube 9, which has many small openings and is places within the soil compartment. Syringe 10 connects to opening 18 and enables to enforce air into the soil compartment via the elongated tube 8 which ends as circular tube 9 through the openings (orifices) 11.

Elongated transparent strip 12 enables to reveal the level of the fluid in the fluid compartment, and it tells when to refill the reservoir.

Another embodiment of this feature is to make the outer wall out of transparent plastic, thus revealing the fluid level in a circular-level form.

One embodiment of the opening (passage) from the fluid compartment to the soil compartment is the triangular orifice 13. The orifice is covered by sliding rectangular door 14.

The sliding door defines the size of the triangular orifice, from the pin-point position 15 of FIG. 3, to a relatively wider triangular 15 of FIG. 4.

Arrow 16 reveals the directions of movement of the rectangular sliding door 14 relative to the triangular opening 13. The size of the opening will determine the rate of flow. Thus, for a plant that needs more water the opening could be enlarged, and for a plant which needs small amount of water, the opening could be left in the pin-point position. The flow of the fluid could be adjusted to the needs of the plant.

Another embodiment of the invention would be a shutter circular design like that found in a photographic camera. (This shutter enables a circular adjustment of the size of the opening orifice namely a circular opening).

The triangular opening 13 is separated from the soil department by means of plastic, or nylon, or silk, (or any material that is not biodegradable) permeable diaphragm 17. This diaphragm is placed and adhered on the inner side of the inner wall 2 of the double wall plant pot structure. The diaphragm (grid) allows fluids to flow from the fluid compartment 3 to the soil compartment 4; yet, it prevents the soil to pass into the fluid compartment. Holes 11 in the circular tube 9 are also covered by means that are not biodegradable. Thus allowing air to flow, and at the same time stop the soil from penetrating to air tubes 9 and 8.

Mode of Action:

The hydrostatic pressure in the fluid compartment pushes the water and the soluble nutrients into the plant and soil compartment through opening 13.

The capillary pressure in the soil granules facilitates the spreading fluids to all parts of the soil compartment.

The sliding rectangular door 14 enables to regulate the rate of flow of fluids from the reservoir fluid compartment to the soil compartment. The size of the opening could be adjusted according to the needs of the plant.

The grid 17 (diaphragm) prevents soil from falling to the fluid compartment while allowing the fluids to flow to the soil compartment.

Syringe 10 is used to inject air into the soil compartment through the opening 18, to the circular tube 9 with its many holes, thus allows to aerate the soil compartment efficiently. The idea is that the user, from time to time, injects air to the area adjacent to the root of the plant.

1.) Plant pot having 2 walls thus forming 2 compartments; fluid compartment and soil compartment and:
a.) Means to regulate to regulate the rate of flow of fluids from the fluid compartment to the soil compartment, through an opening in the inner wall of the plant pot.
b.) Means to inject air to the soil compartment including: syringe, elongated tube and circular tube with holes.
c.) Means to screw the inner wall to the outer wall.
d.) Opening on the inner wall (with cover screw) to enable refilling of the fluid compartment.
f.) Means to prevent soil from the soil compartment to penetrate to the fluid compartment, yet allowing fluids to flow to the soil compartment.

2.) A triangular orifice in the inner wall, with a rectangular sliding door to allow regulating (adjusting) the flow of fluid from the fluid to the soil compartments respectively.

3.) Claim 1 and a camera shutter like device to form an adjustable circular orifice between the fluid compartment and the soil compartment.
